(19) United States
(12) Patent Application Publication
(10) Pub. No.: US 2017/0307882 A1
(43) Pub. Date: Oct. 26, 2017

(54) HEAD UP DISPLAY WITH ENHANCED MAGNIFICATION

(71) Applicant: Panasonic Automotive Systems Company of America, Division of Panasonic Corporation of North America, Peachtree City, GA (US)

(72) Inventors: DAVID KAY LAMBERT, STERLING HEIGHTS, MI (US); WALTER JOSEPH NILL, DAVISON, MI (US)

(21) Appl. No.: 15/486,615

(22) Filed: Apr. 13, 2017

Related U.S. Application Data
(60) Provisional application No. 62/327,737, filed on Apr. 26, 2016.

(51) Int. Cl. G02B 27/01; B60K 35/00

(52) U.S. Cl. CPC G02B 27/0101; B60K 35/00; B60K 2350/901; B60K 2350/203; G02B 2027/0123; B60K 2350/2052

(57) ABSTRACT

A head up display arrangement for a motor vehicle includes an image source providing an illuminated image. A first concave mirror is positioned to provide a first reflection of the illuminated image. A second concave mirror is positioned to receive the first reflection and provide a second reflection of the illuminated image. A windshield is positioned to receive the second reflection and provide a third reflection of the illuminated image such that the third reflection is visible to a driver of the vehicle.

### CROSS-REFERENCE TO RELATED APPLICATION

This application claims benefit of U.S. Provisional Application No. 62/327,737 filed on Apr. 26, 2016, which the disclosure of which is hereby incorporated by reference in its entirety for all purposes.

### FIELD OF THE INVENTION

The disclosure relates to a head up display in a motor vehicle.

### BACKGROUND OF THE INVENTION

Automotive head up displays have traditionally had a field of view of about 5°×3°, to present simple information such as speed, below the driver's view of the road ahead. Increasingly, automakers would like to implement additional features, such as augmented reality, that require a larger field of view.

The currently used automotive head up displays primarily use a large concave mirror (aspherical) and a small flat mirror. There is no internal focus.

### SUMMARY

The present invention may provide an optical arrangement for a head up display with a larger field of view than is currently possible with a conventional automotive head up display.

In one embodiment, the invention comprises a head up display arrangement for a motor vehicle, including an image source providing an illuminated image. A first concave mirror is positioned to provide a first reflection of the illuminated image. A second concave mirror is positioned to receive the first reflection and provide a second reflection of the illuminated image. A windshield is positioned to receive the second reflection and provide a third reflection of the illuminated image such that the third reflection is visible to a driver of the vehicle.

In another embodiment, the invention comprises a head up display method for a motor vehicle, including providing an illuminated image. The illuminated image is reflected off of a first concave mirror to provide a first reflection of the illuminated image. The first reflection is reflected off of a second concave mirror to provide a second reflection of the illuminated image. The second reflection is reflected off of a windshield to provide a third reflection of the illuminated image such that the third reflection is visible to a driver of the vehicle.

In yet another embodiment, the invention comprises a head up display arrangement for a motor vehicle, including a display screen configured to display an image. A first aspherical, concave mirror is positioned to provide a first reflection of the image. A second aspherical, concave mirror is positioned to receive the first reflection and provide a second reflection of the illuminated image. A windshield is positioned to receive the second reflection and provide a third reflection of the illuminated image such that the third reflection is visible to a driver of the vehicle.

An advantage of the present invention is that it may provide a wide field of view from a compact package with a small, relatively low-cost image source.

### BRIEF DESCRIPTION OF THE DRAWINGS

A better understanding of the present invention will be had upon reference to the following description in conjunction with the accompanying drawings.

FIG. 1 is a schematic diagram of one example embodiment of an automotive head up display arrangement of the present invention.

FIG. 2 is a flow chart of one example embodiment of a head up display method of the present invention for a motor vehicle.

### DETAILED DESCRIPTION OF THE PREFERRED EMBODIMENTS

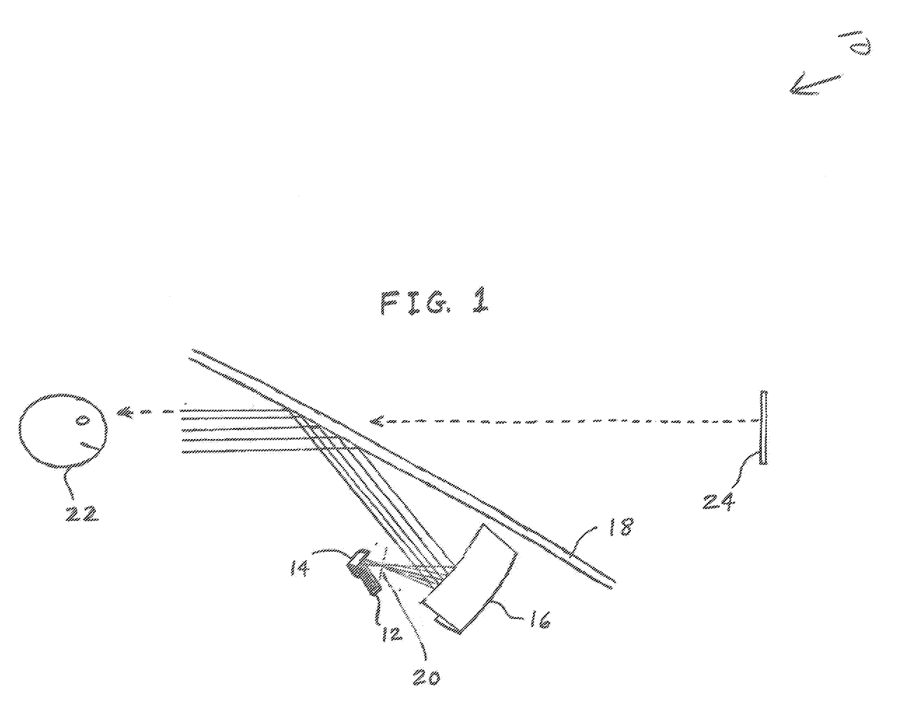

FIG. 1 illustrates in a side view one embodiment of an automotive head up display arrangement 10 of the present invention, including an image source 12, a first freeform concave aspherical mirror 14, a second freeform concave aspherical mirror 16, and a windshield 18.

Both reflective freeform mirrors 14, 16 are concave, and are arranged to provide an intermediate focus 20 between the two mirrors. Light from image source 12 reflects from the first, smaller freeform mirror 14, passes through intermediate focus 20, reflects from the second, larger freeform mirror 16, and reflects from windshield 18 to be seen by a human driver 22. The driver sees the virtual image 24 as being disposed beyond windshield 18. Virtual image 24 is inverted from the image produced on image source 12, which may be a display screen. In one embodiment, image source 12 is a 40 mm×20 mm liquid crystal display.

In one embodiment, virtual image 24 measures 10°×4° as seen by the driver, with a seven-meter distance between driver 22 and virtual image 24. In one embodiment, image source 12 and mirrors 14, 16 are included in a head up display package with a volume of 7.2 liters.

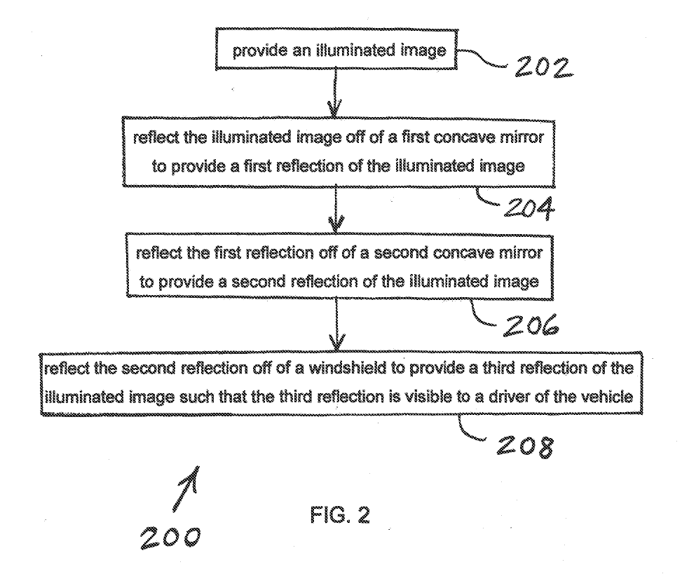

FIG. 2 illustrates one example embodiment of a head up display method of the present invention for a motor vehicle. In a first step 202, an illuminated image is provided. For example, image source 12 may provide a light field.

In a next step 204, the illuminated image is reflected off of a first concave mirror to provide a first reflection of the illuminated image. For example, the light field from image source 12 may be reflected off of a first concave mirror 14 to provide a first reflection.

Next, in step 206, the first reflection is reflected off of a second concave mirror to provide a second reflection of the illuminated image. For example, the reflection off of mirror 14 may be further reflected off of second concave mirror 16 to provide a second reflection of the illuminated image.

In a final step 208, the second reflection is reflected off of a windshield to provide a third reflection of the illuminated image such that the third reflection is visible to a driver of the vehicle. For example, the reflection off of mirror 16 may be further reflected off of windshield 18 to provide a third reflection of the illuminated image that is visible to driver 22 as a virtual image 24.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
an image source configured to provide an illuminated image;
a first concave mirror positioned to provide a first reflection of the illuminated image;
a second concave mirror positioned to receive the first reflection and provide a second reflection of the illuminated image; and
a windshield positioned to receive the second reflection and provide a third reflection of the illuminated image such that the third reflection is visible to a driver of the vehicle.

2. The head up display arrangement of claim 1 wherein the image source comprises a display screen.

3. The head up display arrangement of claim 2 wherein the display screen comprises a liquid crystal display.

4. The head up display arrangement of claim 1 wherein an intermediate focus is disposed between the first concave mirror and the second concave mirror.

5. The head up display arrangement of claim 1 wherein the third reflection appears as a virtual image disposed outside the windshield.

6. The head up display arrangement of claim 5 wherein the virtual image is approximately between six and eight meters from the driver.

7. The head up display arrangement of claim 5 wherein the virtual image measures 10°×4° as seen by the driver.

8. A head up display method for a motor vehicle, the method comprising:
providing an illuminated image;
reflecting the illuminated image off of a first concave mirror to provide a first reflection of the illuminated image;
reflecting the first reflection off of a second concave mirror to provide a second reflection of the illuminated image; and
reflecting the second reflection off of a windshield to provide a third reflection of the illuminated image such that the third reflection is visible to a driver of the vehicle.

9. The head up display method of claim 8 wherein the illuminated image is provided by a display screen.

10. The head up display method of claim 9 wherein the display screen comprises a liquid crystal display.

11. The head up display method of claim 8 wherein an intermediate focus is disposed between the first concave mirror and the second concave mirror.

12. The head up display method of claim 8 wherein the third reflection appears as a virtual image disposed outside the windshield.

13. The head up display method of claim 12 wherein the virtual image is approximately between six and eight meters from the driver.

14. The head up display method of claim 12 wherein the virtual image measures 10°×4° as seen by the driver.

15. A head up display arrangement for a motor vehicle, the arrangement comprising:
a display screen configured to display an image;
a first aspherical, concave mirror positioned to provide a first reflection of the image;
a second aspherical, concave mirror positioned to receive the first reflection and provide a second reflection of the illuminated image; and
a windshield positioned to receive the second reflection and provide a third reflection of the illuminated image such that the third reflection is visible to a driver of the vehicle.

16. The head up display arrangement of claim 15 wherein the display screen comprises a liquid crystal display.

17. The head up display arrangement of claim 15 wherein an intermediate focus is disposed between the first aspherical, concave mirror and the second aspherical, concave mirror.

18. The head up display arrangement of claim 15 wherein the third reflection appears as a virtual image disposed outside the windshield.

19. The head up display arrangement of claim 18 wherein the virtual image is approximately between six and eight meters from the driver.

20. The head up display arrangement of claim 18 wherein the virtual image measures 10°×4° as seen by the driver.
